(19) United States
(12) Patent Application Publication
(10) Pub. No.: US 2025/0016604 A1
(43) Pub. Date: Jan. 9, 2025

(54) METHOD AND DEVICE FOR WIRELESS COMMUNICATION

(71) Applicant: GUANGDONG OPPO MOBILE TELECOMMUNICATIONS CORP., LTD., Dongguan (CN)

(72) Inventor: Rongyi HU, Dongguan (CN)

(21) Appl. No.: 18/894,581

(22) Filed: Sep. 24, 2024

Related U.S. Application Data
(63) Continuation of application No. PCT/CN2022/085050, filed on Apr. 2, 2022.

(51) Int. Cl. H04W 28/02; H02J 50/00; H04B 1/16; H04B 7/22

(52) U.S. Cl. CPC H04W 28/0215; H02J 50/001; H04B 1/1638; H04B 7/22

(57) ABSTRACT

A method for wireless communication, in which a first communication device supports an enhanced backscatter coverage distance capability. The method for wireless communication includes: transmitting, by the first communication device, a backscatter signal; where the first communication device obtains power through power harvesting for communication, information collection and information processing, and the first communication device supports an enhanced backscatter coverage distance capability.

### CROSS-REFERENCE TO RELATED APPLICATION

This application is a Continuation application of PCT/CN2022/085050 filed Apr. 2, 2022, which is incorporated herein by reference in its entirety.

### TECHNICAL FIELD

Embodiments of the present application relate to the field of communication, and in particular, to a method and device for wireless communication.

### BACKGROUND

In zero-power-consumption communication, a zero-power-consumption terminal needs to collect radio waves to obtain power before the zero-power-consumption terminal can drive itself to operate. In scenarios such as logistics warehouse management, and supermarket shopping, more zero-power-consumption terminals require accessing. However, a backscatter coverage distance of the zero-power-consumption terminal is limited, which affects backscatter communication of the zero-power-consumption terminal.

### SUMMARY

In a first aspect, a method for wireless communication is provided, and the method includes:
transmitting, by a first communication device, a backscatter signal;
where the first communication device obtains power through power harvesting for communication, information collection, and information processing, and the first communication device supports an enhanced backscatter coverage distance capability.

In a second aspect, a method for wireless communication is provided, and the method includes:
receiving, by a second communication device, a backscatter signal transmitted by a first communication device;
where the first communication device obtains power through power harvesting for communication, information collection, and information processing, and the first communication device supports an enhanced backscatter coverage distance capability.

In a third aspect, a terminal device is provided, which is configured to perform the method according to the above first aspect.

Specifically, the terminal device includes a functional module configured to perform the method according to the above first aspect.

In a fourth aspect, a communication device is provided, which is configured to perform the method according to the above second aspect.

Specifically, the communication device includes a functional module configured to perform the method according to the above second aspect.

In a fifth aspect, a communication device is provided, which includes a processor and a memory. The memory is configured to store a computer program, and the processor is configured to call and run the computer program stored in the memory to cause the communication device to perform the method according to the above first aspect.

In a sixth aspect, a communication device is provided, which includes a processor and a memory. The memory is configured to store a computer program, and the processor is configured to call and run the computer program stored in the memory to cause the communication device to perform the method according to the above second aspect.

In a seventh aspect, an apparatus is provided, which is configured to implement the method according to any one of the above first and second aspects.

Specifically, the apparatus includes: a processor configured to call and run a computer program from a memory to cause a device installed with the apparatus to perform the method according to any one of the above first and second aspects.

In an eighth aspect, a non-transitory computer-readable storage medium is provided, which is configured to store a computer program that causes a computer to perform the method according to any one of the above first and second aspects.

In a ninth aspect, a computer program product is provided, which includes computer program instructions. The computer program instructions cause a computer to perform the method according to any one of the above first and second aspects.

In a tenth aspect, a computer program is provided. When executed on a computer, the computer program causes the computer to perform the method according to any one of the above first and second aspects.

### BRIEF DESCRIPTION OF THE DRAWINGS

FIG. 1 is a schematic diagram of a communication system architecture to which embodiments of the present application is applicable.

FIG. 2 is a schematic diagram showing a principle of zero-power-consumption communication provided by the present application.

FIG. 3 is a schematic diagram showing a principle of backscatter communication provided by the present application.

FIG. 4 is a schematic diagram showing a principle of power harvesting provided by the present application.

FIG. 5 is a schematic diagram showing a circuit principle of resistive load modulation provided by the present application.

FIG. 6 is a schematic diagram showing low power consumption provided by the present application.

FIG. 7 is a schematic diagram showing envelope detection provided by the present application.

FIG. 8 is a schematic diagram showing backscatter provided by the present application.

FIG. 9 is a schematic flowchart of a method for wireless communication according to embodiments of the present application.

FIG. 10 is a schematic diagram showing backscatter according to embodiments of the present application.

FIG. 11 is another schematic diagram showing backscatter according to embodiments of the present application.

FIG. 12 is a schematic block diagram of a communication device according to embodiments of the present application.

FIG. 13 is another schematic block diagram of a communication device according to embodiments of the present application.

FIG. 14 is yet another schematic block diagram of a communication device according to embodiments of the present application.

FIG. 15 is a schematic block diagram of an apparatus according to embodiments of the present application.

FIG. 16 is a schematic block diagram of a communication system according to embodiments of the present application.

### DETAILED DESCRIPTION

Technical solutions in the embodiments of the present application will be described below with reference to the accompanying drawings in the embodiments of the present application. It is apparent that the embodiments described are some rather than all of the embodiments of the present application. Based on the embodiments of the present application, all other embodiments obtained by a person of ordinary skill in the art fall within the protection scope of the present application.

The technical solutions in the embodiments of the present disclosure can be applied to various communication systems, such as a global system of mobile communication (GSM) system, a code division multiple access (CDMA) system, a wideband code division multiple access (WCDMA) system, a general packet radio service (GPRS), a long term evolution (LTE) system, an advanced long term evolution (LTE-A) system, a new radio (NR) system, an evolution system of the NR system, an LTE-based access to unlicensed spectrum (LTE-U) system, an NR-based access to unlicensed spectrum (NR-U) system, a non-terrestrial networks (NTN) system, a universal mobile telecommunications system (UMTS), a wireless local area network (WLAN), an internet of things (IoT), wireless fidelity (WiFi), a 5th-Generation (5G) communication system, and other communication systems.

Generally, conventional communication systems support a limited quantity of connections, and are easy to implement. However, with the development of communication technology, mobile communication systems will not only support traditional communication, but also support, for example, device to device (D2D) communication, machine to machine (M2M) communication, machine type communication (MTC), vehicle to vehicle (V2V) communication, or vehicle to everything (V2X) communication, and the embodiments of the present application may be applied to these communication systems as well.

In some embodiments, the communication system in the embodiments of the present application may be applied to a carrier aggregation (CA) scenario, a dual connectivity (DC) scenario, a standalone (SA) network deployment scenario, or a non-standalone (NSA) network deployment scenario.

In some embodiments, the communication systems in the embodiments of the present application may be applied to an unlicensed spectrum, which may also be considered as a shared spectrum. Alternatively, the communication systems in the embodiments of the present application may also be applied to a licensed spectrum, which may also be considered as an unshared spectrum.

In some embodiments, the communication system in the embodiments of the present application may be applied to the FR1 frequency band (corresponding to the frequency band range of 410 MHz to 7.125 GHZ), the FR2 frequency band (corresponding to the frequency band range of 24.25 GHz to 52.6 GHZ), and a new frequency band, such as a high frequency band corresponding to the frequency band range of 52.6 GHz to 71 GHz or the frequency band range of 71 GHz to 114.25 GHz.

Various embodiments of the present application are described in combination with a network device and a terminal device. The terminal device may also be referred to as a user equipment (UE), an access terminal, a subscriber unit, a subscriber station, a mobile station, a mobile console, a remote station, a remote terminal, a mobile device, a user terminal, a terminal, a wireless communication device, a user agent or a user apparatus.

The terminal device may be a station (ST) in the WLAN, or may be a cellular phone, a wireless phone, a session initiation protocol (SIP) phone, a wireless local loop (WLL) station, a personal digital assistant (PDA) device, a handheld device with a wireless communication function, a computing device or another processing device connected to a wireless modem, a vehicle-mounted device, a wearable device, a terminal device in a next generation communication system (e.g., an NR network), or a terminal device in a future evolved public land mobile network (PLMN).

In embodiments of the present application, the terminal device may be deployed on land including indoor or outdoor, handheld, wearable or vehicle-mounted; alternatively the terminal device may be deployed on water (such as on ships); alternatively the terminal device may be deployed acrially (such as in airplanes, balloons and satellites).

In embodiments of the present application, the terminal device may be a mobile phone, a Pad, a computer with wireless transceiving function, a virtual reality (VR) terminal device, an augmented reality (AR) terminal device, a wireless terminal device in industrial control, a wireless terminal device in self driving, a wireless terminal device in remote medical, a wireless terminal device in smart grid, a wireless terminal device in transportation safety, a wireless terminal device in smart city, a wireless terminal device in smart home, a vehicle-mounted communication device, a wireless communication chip/application-specific integrated circuit (ASIC)/system on chip (SoC), or the like.

As an example and not by way of limitation, the terminal device in embodiments of the present application may also be a wearable device. The wearable device may also be referred to as a wearable smart device, which is a general term of wearable devices developed by intelligent design on daily wear by applying wearable technology, such as glasses, gloves, a watch, clothing and shoes. The wearable device is a portable device that is worn directly on a body, or integrated into clothes or accessories of a user. The wearable device is not only a hardware device, but also implements powerful functions through software support as well as data interaction or cloud interaction. Generalized wearable smart devices include devices which are fully functional, have large sizes, and may implement complete or partial functions without relying on smart phones, such as a smart watch or smart glasses, and devices which focus on a certain kind of application functions only and need to be used in conjunction with other devices such as smart phones, such as various smart bracelets, and smart jewelries for monitoring physical signs.

In embodiments of the present application, the network device may be a device configured to communicate with a mobile device, and may be an access point (AP) in the WLAN, a base transceiver station (BTS) in GSM or CDMA, a NodeB (NB) in WCDMA, an evolutional node B (eNB or eNodeB) in LTE, a relay station, an access point, a vehicle-mounted device, a wearable device, a network device or a gNB in an NR network, a network device in the future evolved PLMN network, or a network device in an NTN network.

As an example rather than limitation, the network device in an embodiment of present application may be of mobility. For example, the network device may be a mobile device. In some embodiments, the network device may be a satellite, or a balloon station. For example, the satellite may be a low earth orbit (LEO) satellite, a medium earth orbit (MEO) satellite, a geostationary earth orbit (GEO) satellite, a high elliptical orbit (HEO) satellite, or the like. In some embodiments, the network device may also be a base station disposed in a position on land or in a water region.

In embodiments of the present application, the network device may provide a service for a cell, and the terminal device communicates with the network device through a transmission resource (e.g., a frequency-domain resource, which is also referred to as a spectrum resource) used by the cell. The cell may be a cell corresponding to the network device (e.g., a base station), and the cell may belong to a macro base station, or may belong to a base station corresponding to a small cell. Small cells herein may include a metro cell, a micro cell, a pico cell, a femto cell, and the like. These small cells are characterized by a small coverage range and a low transmit power, and are suitable for providing high-speed data transmission services.

The embodiments of the present application provide a method for wireless communication, which includes:
transmitting, by a first communication device, a backscatter signal;
where the first communication device obtains power through power harvesting for communication, information collection and information processing, and the first communication device supports an enhanced backscatter coverage distance capability.

In some embodiments, that the first communication device supports the enhanced backscatter coverage distance capability is determined based on at least one of following:
a sensitivity of a receiver of a second communication device, a receive antenna gain of the second communication device, a transmit power of a carrier signal of a third communication device, a transmit antenna gain of the third communication device, location information of the third communication device, angle information of a scanning antenna of the third communication device, an operating frequency of a carrier signal of the third communication device, an operating frequency of the backscatter signal, a frequency shifting capability supported by the first communication device, or a reflection capability of the first communication device;
where a receiving terminal of the backscatter signal is the second communication device, and a power supply signal and/or trigger signal corresponding to the backscatter signal are transmitted by the third communication device.

In some embodiments, in a case where supporting of the enhanced backscatter coverage distance capability by the first communication device is determined based on at least the sensitivity of the receiver of the second communication device, the receiver of the second communication device supports an enhanced sensitivity.

In some embodiments, the second communication device causes its receiver to support the enhanced sensitivity by reducing a reception bandwidth of the second communication device; and/or,
the second communication device causes its receiver to support the enhanced sensitivity by reducing an insertion loss of a conductive circuit operating on a receive frequency band of the second communication device.

In some embodiments, in a case where supporting of the enhanced backscatter coverage distance capability by the first communication device is determined based on at least the receive antenna gain of the second communication device, the second communication device supports an enhanced receive antenna gain.

In some embodiments, the second communication device receives the backscatter signal using n receive (Rx) antennas, and n is a positive integer larger than or equal to 2.

In some embodiments, in a case where supporting of the enhanced backscatter coverage distance capability by the first communication device is determined based on at least the transmit power of the carrier signal of the third communication device, the carrier signal of the third communication device corresponds to an enhanced transmit power.

In some embodiments, in a case where supporting of the enhanced backscatter coverage distance capability by the first communication device is determined based on at least the transmit antenna gain of the third communication device, the third communication device supports an enhanced transmit antenna gain. The transmit antenna gain includes a diversity gain or a beamforming gain.

In some embodiments, in a case where supporting of the enhanced backscatter coverage distance capability by the first communication device is determined based on at least the location information of the third communication device, a distance between the third communication device and the first communication device is less than or equal to a first preset value.

In some embodiments, in a case where supporting of the enhanced backscatter coverage distance capability by the first communication device is determined based on at least the angle information of the scanning antenna of the third communication device, a maximum radiated power corresponding to the angle information of the scanning antenna of the third communication device is directed to the first communication device.

In some embodiments, in a case where supporting of the enhanced backscatter coverage distance capability by the first communication device is determined based on at least the operating frequency of the carrier signal of the third communication device, or in case where supporting of the enhanced backscatter coverage distance capability by the first communication device is determined based on at least the operating frequency of the backscatter signal, the third communication device reduces the operating frequency of the carrier signal of the third communication device to a first frequency, and modulates the operating frequency of the backscatter signal to a target frequency based on frequency multiplication information or frequency mixing information of the first frequency.

In some embodiments, in a case where supporting of the enhanced backscatter coverage distance capability by the first communication device is determined based on at least the frequency shift capability supported by the first communication device, the frequency shift capability supported by the first communication device includes increasing or decreasing a frequency with a first frequency modulation interval, or the frequency shift capability supported by the first communication device includes increasing or decreasing a frequency with a plurality of frequency modulation intervals.

In some embodiments, the first frequency modulation interval is defined by a protocol, or the first frequency modulation interval is configured by a network device.

In some embodiments, the plurality of frequency modulation intervals are defined by a protocol, or the plurality of frequency modulation intervals are configured by a network device.

In some embodiments, an operating frequency of the first communication device is modulated from a wireless fidelity (WiFi) signal to a Bluetooth broadcast signal frequency through frequency shift keying modulation (FSK), or the operating frequency of the first communication device is modulated from a cellular network signal to a Bluetooth broadcast signal frequency through FSK.

In some embodiments, in a case where supporting of the enhanced backscatter coverage distance capability by the first communication device is determined based on at least the reflection capability of the first communication device, the first communication device supports an enhanced reflection capability.

In some embodiments, the first communication device causes itself to support the enhanced reflection capability by reducing an insertion loss of a conductive circuit of the first communication device, or the first communication device causes itself to support the enhanced reflection capability by reducing an insertion loss corresponding to a carrier frequency of the first communication device.

In some embodiments, the first communication device is caused to support the enhanced reflection capability by increasing an antenna area of a built-in antenna of the first communication device, and/or the first communication device is caused to support the enhanced reflection capability by increasing a reflection cross section of the built-in antenna of the first communication device, and/or the first communication device is caused to support the enhanced reflection capability by increasing an efficiency of the built-in antenna of the first communication device; and/or,
an external antenna of the first communication device employs a directional antenna, and the first communication device is caused to support the enhanced reflection capability by increasing a gain of the directional antenna.

In some embodiments, the second communication device is co-located with the third communication device.

In some embodiments, the second communication device and the third communication device are different devices; or,
the second communication device and the third communication device are a same device.

The embodiments of the present application further provide a method for wireless communication, which includes:
receiving, by a second communication device, a backscatter signal transmitted by a first communication device;
where the first communication device obtains power through power harvesting for communication, information collection and information processing, and the first communication device supports an enhanced backscatter coverage distance capability.

In some embodiments, that the first communication device supports the enhanced backscatter coverage distance capability is determined based on at least one of following:
a sensitivity of a receiver of the second communication device, a receive antenna gain of the second communication device, a transmit power of a carrier signal of a third communication device, a transmit antenna gain of the third communication device, location information of the third communication device, angle information of a scanning antenna of the third communication device, an operating frequency of a carrier signal of the third communication device, an operating frequency of the backscatter signal, a frequency shifting capability supported by the first communication device, or a reflection capability of the first communication device;
where a power supply signal and/or trigger signal corresponding to the backscatter signal are transmitted by the third communication device.

In some embodiments, in a case where supporting of the enhanced backscatter coverage distance capability by the first communication device is determined based on at least the sensitivity of the receiver of the second communication device, the receiver of the second communication device supports an enhanced sensitivity.

In some embodiments, the second communication device causes its receiver to support the enhanced sensitivity by reducing a reception bandwidth of the second communication device; and/or,
the second communication device causes its receiver to support the enhanced sensitivity by reducing an insertion loss of a conductive circuit operating on a receive frequency band of the second communication device.

In some embodiments, in a case where supporting of the enhanced backscatter coverage distance capability by the first communication device is determined based on at least the receive antenna gain of the second communication device, the second communication device supports an enhanced receive antenna gain.

In some embodiments, the second communication device receives the backscatter signal using n receive (Rx) antennas, and n is a positive integer larger than or equal to 2.

In some embodiments, in a case where supporting of the enhanced backscatter coverage distance capability by the first communication device is determined based on at least the transmit power of the carrier signal of the third communication device, the carrier signal of the third communication device corresponds to an enhanced transmit power.

In some embodiments, in a case where supporting of the enhanced backscatter coverage distance capability by the first communication device is determined based on at least the transmit antenna gain of the third communication device, the third communication device supports an enhanced transmit antenna gain;
where the transmit antenna gain includes a diversity gain or a beamforming gain.

In some embodiments, in a case where supporting of the enhanced backscatter coverage distance capability by the first communication device is determined based on at least the location information of the third communication device, a distance between the third communication device and the first communication device is less than or equal to a first preset value.

In some embodiments, in a case where supporting of the enhanced backscatter coverage distance capability by the first communication device is determined based on at least the angle information of the scanning antenna of the third communication device, a maximum radiated power corresponding to the angle information of the scanning antenna of the third communication device is directed to the first communication device.

In some embodiments, in a case where supporting of the enhanced backscatter coverage distance capability by the first communication device is determined based on at least the operating frequency of the carrier signal of the third communication device, or in case where supporting of the enhanced backscatter coverage distance capability by the first communication device is determined based on at least the operating frequency of the backscatter signal, the third communication device reduces the operating frequency of the carrier signal of the third communication device to a first frequency and modulates the operating frequency of the backscatter signal to a target frequency based on frequency multiplication information or frequency mixing information of the first frequency.

In some embodiments, in a case where supporting of the enhanced backscatter coverage distance capability by the first communication device is determined based on at least the frequency shift capability supported by the first communication device, the frequency shift capability supported by the first communication device includes increasing or decreasing a frequency with a first frequency modulation interval, or the frequency shift capability supported by the first communication device includes increasing or decreasing a frequency with a plurality of frequency modulation intervals.

In some embodiments, the first frequency modulation interval is defined by a protocol, or the first frequency modulation interval is configured by a network device.

In some embodiments, the plurality of frequency modulation intervals are defined by a protocol, or the plurality of frequency modulation intervals are configured by a network device.

In some embodiments, an operating frequency of the first communication device is modulated from a wireless fidelity (WiFi) signal to a Bluetooth broadcast signal frequency through frequency shift keying modulation (FSK), or the operating frequency of the first communication device is modulated from a cellular network signal to a Bluetooth broadcast signal frequency through FSK.

In some embodiments, in a case where supporting of the enhanced backscatter coverage distance capability by the first communication device is determined based on at least the reflection capability of the first communication device, the first communication device supports an enhanced reflection capability.

In some embodiments, the first communication device causes itself to support the enhanced reflection capability by reducing an insertion loss of a conductive circuit of the first communication device, or the first communication device causes itself to support the enhanced reflection capability by reducing an insertion loss corresponding to a carrier frequency of the first communication device.

In some embodiments, the first communication device is caused to support the enhanced reflection capability by increasing an antenna area of a built-in antenna of the first communication device, and/or the first communication device is caused to support the enhanced reflection capability by increasing a reflection cross section of the built-in antenna of the first communication device, and/or the first communication device is caused to support the enhanced reflection capability by increasing an efficiency of the built-in antenna of the first communication device; and/or,
an external antenna of the first communication device employs a directional antenna, and the first communication device is caused to support the enhanced reflection capability by increasing a gain of the directional antenna.

In some embodiments, the second communication device is co-located with the third communication device.

In some embodiments, the second communication device and the third communication device are different devices; or,
the second communication device and the third communication device are a same device.

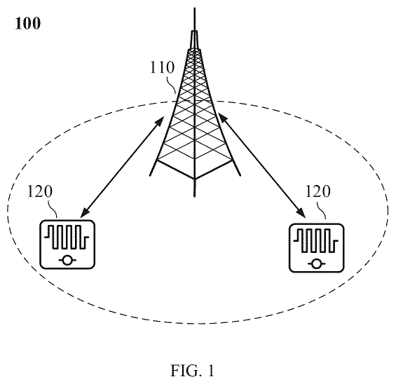

Exemplary, a communication system 100 to which the embodiments of the present application are applicable is shown in FIG. 1. The communication system 100 may include a network device 110, and the network device 110 may be a device that communicates with a terminal device 120 (or referred to as a communication terminal or a terminal). The network device 110 may provide communication coverage for a specific geographical area, and may communicate with the terminal device(s) located in the coverage area.

FIG. 1 exemplarily illustrates one network device and two terminal devices. In some embodiments, the communication system 100 may include a plurality of network devices, each of which may have a coverage area in which other number of terminal devices are included, which is not limited in the embodiments of the present application.

In some embodiments, the communication system 100 may further include a network controller, a mobile management entity or other network entities, which is not limited in the embodiments of the present application.

It should be understood that devices with communication functions in the network/system in the embodiments of the present application may be called communication devices. Taking the communication system 100 shown in FIG. 1 as an example, communication devices may include the network device 110 and the terminal device 120 that have a communication function. The network device 110 and the terminal device 120 may be the devices described above and will not be repeated here. The communication devices may further include other devices in the communication system 100, such as a network controller, a mobile management entity and other network entities, which is not limited in the embodiments of the present application.

It should be understood that terms “system” and “network” herein are often used interchangeably herein. The term “and/or” herein is only an association relationship to describe associated objects, which indicates that there may be three kinds of relationships. For example, A and/or B may indicate three cases where: A exists alone, both A and B exist, and B exists alone. In addition, a character “/” herein generally indicates that related objects before and after the character “/” are in an “or” relationship.

It should be understood that the present application relates to a first communication device and a second communication device. The first communication device may be a terminal device such as a cell phone, a machine facility, a customer premise equipment (CPE), an industrial device, or a vehicle. The second communication device may be a peer communication device of the first communication device, such as a network device, a mobile phone, an industrial device, or a vehicle. The first communication device being a terminal device and the second communication device being a network device are taken as specific examples for description.

Terminologies used in the detailed description of the present application are only for the purpose of explaining specific embodiments of the present application, and are not intended to limit the present application. Terms “first”, “second”, “third”, “fourth”, and the like in the specification, claims and drawings of the present application are used to distinguish different objects and not used to describe a specific order. In addition, terms “include” and “have” and any variations thereof are intended to cover non-exclusive inclusion.

It should be understood that “indication” involved in the embodiments of the present application may be a direct indication, may be an indirect indication, or may represent an association relationship. For example, A indicating B may mean that A indicates B directly, for example, B may be obtained through A; or may mean that A indicates B indirectly, for example, A indicates C, and B may be obtained through C; or may also mean that there is an association between A and B.

In the description of the embodiments of the present application, the term “correspond” may mean that there is a direct or indirect correspondence between two elements, or may indicate an association between two elements, or may indicate a relationship of indicating and being indicated, configuring and being configured, etc.

In embodiments of the present application, “pre-defined” or “pre-configured” may be achieved by pre-storing a corresponding code, a table, or other modes that may be used to indicate related information in a device (e.g., including the terminal device and the network device), and its specific implementation is not limited in the present application. For example, the “predefined” may refer to those defined in a protocol.

In an embodiment of the present application, the “protocol” may refer to a standard protocol in the communication field, for example, may include an LTE protocol, an NR protocol, and a related protocol applied in a future communication system, which are not limited in the present application.

In order to facilitate understanding of the technical solutions of the embodiments of the present application, the technical solutions of the present application will be described in detail in the following through specific embodiments. The following related technologies, as optional solutions, can be arbitrarily combined with the technical solutions of the embodiments of the present application, and these combined solutions all fall within the protection scope of the embodiments of the present application. The embodiments of the present application include at least part of the following contents.

In recent years, zero-power-consumption devices have become more widely used. A typical zero-power-consumption device is a radio frequency identification (RFID) device, which use wireless radio frequency signal spatial coupling to achieve contactless automatic transmission and identification of tag information. The RFID tag is also referred to as “radio frequency tag” or “electronic tag”. According to different ways of power supply to divide the type of electronic tags, electronic tags may be categorized into three types of tags, i.e., active electronic tags, passive electronic tags, and semi-passive electronic tags. An active electronic tag, also referred to as an active type tag, refers to that the electronic tag's work power is provided by a battery, and the battery, memory, and antenna together constitute the active electronic tag. A passive electronic tag, also referred to as a passive type electronic tag, does not support a built-in battery. When the passive electronic tag approaches a reader/writer, the tag is in a near-field range formed by antenna radiation of the reader/writer. The antenna of the electronic tag generates induction current through electromagnetic induction, and the induction current drives a chip circuit of the electronic tag. The chip circuit transmits identification information stored in the tag to the reader/writer through the antenna of the electronic tag. A semi-passive electronic tag inherits advantages of the passive electronic tag, namely, small volume, light weight, low price, and long service life. A built-in battery only provides power supply to very few circuits inside the chip when there is no reader/writer visiting, and provides power supply to the RFID chip only when there is reader/writer visiting, so as to increase the read-write distance of the tag and improve the reliability of the communication.

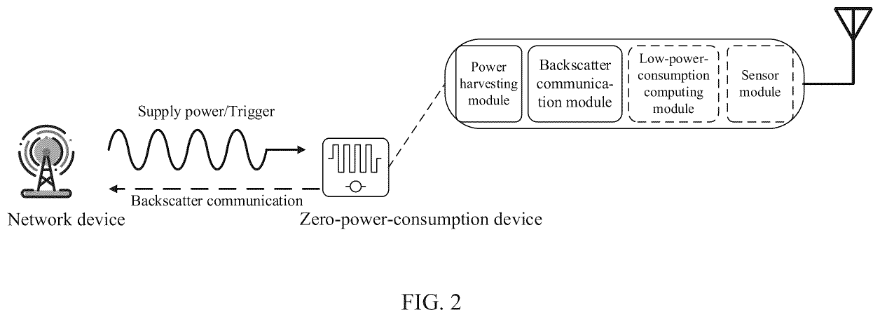

RFID is a wireless communication technology. The most basic RFID system is composed of two parts: an electronic tag (TAG) and a reader/writer (Reader/Writer). The electronic tag is composed of coupling components and a chip, and each electronic tag has a unique electronic code, which is placed on the measured target to achieve a purpose of marking the target object. The reader/writer is not only capable of reading the information on the electronic tag, but also capable of writing the information on the electronic tag, and further provides the electronic tag with the power needed for communication. As shown in FIG. 2, after the electronic tag enters an electromagnetic field, the electronic tag receives a radio frequency signal transmitted from the reader/writer. The passive or semi-passive electronic tag can obtain power through the electromagnetic field generated in the space and transmit the stored information in the electronic tag, and the reader/writer reads the information transmitted by the electronic tag and decodes the information, thereby identifying the electronic tag.

Key technologies for zero-power-consumption communication include power harvesting, backscatter communication, and low-power-consumption computing. As shown in FIG. 2, a typical zero-power-consumption communication system includes a reader/writer and a zero-power-consumption terminal. The reader/writer emits radio waves for providing power to the zero-power-consumption terminal. The power harvesting module installed in the zero-power-consumption terminal may harvest power carried by radio waves in space (e.g., the radio waves emitted by the reader/writer shown in FIG. 2) to drive the low-power-consumption computing module of the zero-power-consumption terminal and achieve backscatter communication. After the zero-power-consumption terminal obtains power, it may receive a control command from the reader/writer and transmit data to the reader/writer in a backscattering manner based on control signaling. The transmitted data may come from the data stored by the zero-power-consumption terminal itself (such as an identification or pre-written information, e.g., a production date, brand, or manufacturer of a product). The zero-power-consumption terminal may be installed with various sensors, so as to report the data collected by the various sensors based on the zero-power-consumption mechanism.

In order to facilitate a better understanding of the embodiments of the present application, backscatter communication (Back Scattering) involved in the present application will be described.

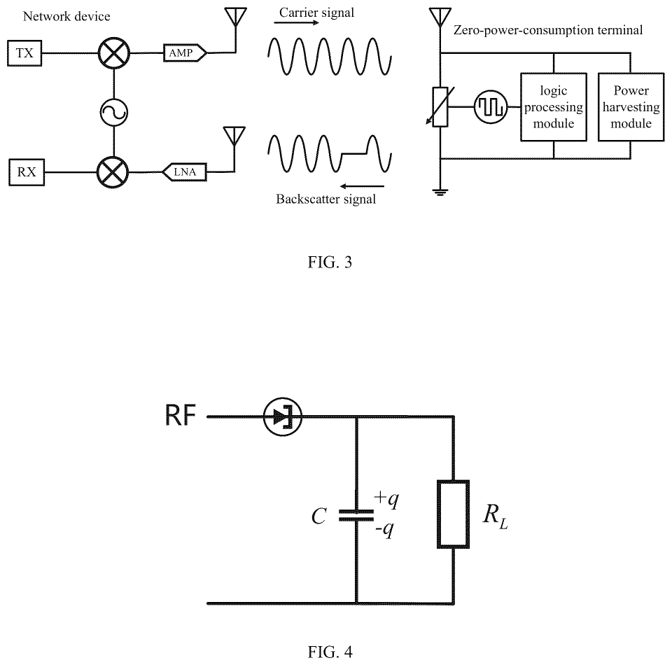

As shown in FIG. 3, a zero-power-consumption device (i.e., a backscatter tag shown in FIG. 3) receives a carrier signal sent by a backscatter reader/writer and harvests power through a radio frequency (RF) power harvesting module. Further, the zero-power-consumption device modulates an incoming signal through a low-power processing module (i.e., a logic processing module shown in FIG. 3) and performs backscatter.

The main characteristics of backscatter communication are as follows:
(1) the terminal does not actively transmit signals and realizes backscatter communication by modulating incoming signals;
(2) the terminal does not rely on a traditional active amplifier transmitter and uses the low-power-consumption computing module, which greatly reduces the hardware complexity; and
(3) combined with a power harvesting unit, battery-free communication may be realized.

In order to facilitate a better understanding of the embodiments of the present application, RF power harvesting (Power Harvesting) involved in the present application will be described.

As shown in FIG. 4, an RF module is utilized to harvest power electromagnetic wave in space through electromagnetic induction, and then realize the drive of a load circuit (e.g., the low-power computing module, sensors, etc.), so as to realize the battery-free communication.

In order to facilitate a better understanding of the embodiments of the present application, load modulation involved in the present application will be described.

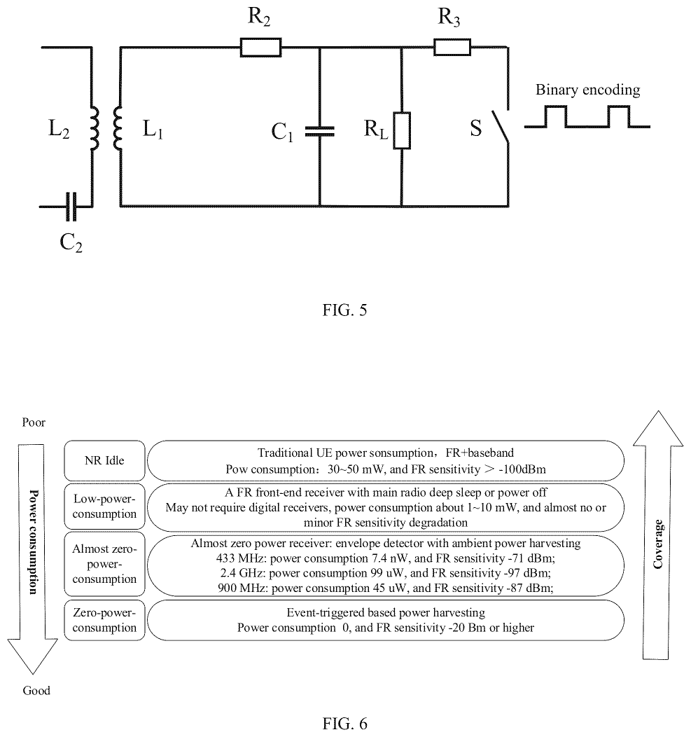

The load modulation is a method often applied by the electronic tag to transmit data to the reader/writer. The load modulation completes the modulation process by adjusting electrical parameters of an oscillation loop of the electronic tag according to a beat of the data stream, such that the magnitude and phase of impedance of the electronic tag change accordingly. The load modulation technology mainly includes resistive load modulation and capacitive load modulation. In the resistive load modulation, the load is connected in parallel with a resistor, known as a load modulation resistor. The resistor is turned on and off according to a clock of the data stream, and the on-off of a switch S is controlled by binary data coding. The schematic diagram showing the circuit principle of the resistive load modulation is shown in FIG. 5.

In the capacitive load modulation, the load is connected in parallel with a capacitor that replaces the load modulation resistor controlled by binary data coding in FIG. 5.

In order to facilitate a better understanding of the embodiments of the present application, encoding technologies involved in the present application will be described.

Data transmitted by an electronic tag may be represented by binary one (“1”) and binary zero (“0”) through different forms of codes. A wireless radio frequency identification system typically uses one of the following encoding methods: non-return-to-zero (NRZ) inverted encoding, Manchester encoding, unipolar return-to-zero (Unipolar RZ) encoding, differential bi-phase (DBP) encoding, Miller encoding, and differential encoding. Colloquially, different encoding technologies use different pulse signals to represent 0 and 1.

In order to facilitate a better understanding of the embodiments of the present application, power supply signals related to the zero-power-consumption communication system involved in the present application will be described.

In terms of carrier of the power supply signal, the carrier may be a base station, a smart phone, a smart gateway, a charging station, a micro base station, or the like.

In terms of frequency band, the frequency band of radio waves used for power supply may be a low frequency band, an intermediate frequency band, or a high frequency band.

In terms of waveform, the radio waves used for power supply may be sine waves, square waves, triangle waves, pulses, rectangular waves, or the like. In addition, the power supply signal may be a continuous wave or a non-continuous wave (that is, a certain period of interruption is allowed).

The power supply signal may be a signal defined in 3GPP standards, such as a sounding reference signal (SRS), a physical uplink shared channel (PUSCH), a physical random access channel (PRACH), a physical uplink control channel (PUCCH), a physical downlink control channel (PDCCH), a physical downlink shared channel (PDSCH), a physical broadcast channel (PBCH).

In order to facilitate a better understanding of the embodiments of the present application, trigger signals related to the zero-power-consumption communication system involved in the present application will be described.

In terms of carrier of the power supply signal, the carrier may be a base station, a smart phone, a smart gateway, or the like.

In terms of frequency band, the radio waves used for triggering or scheduling may have a low frequency, an intermediate frequency, a high frequency, or the like.

In terms of waveform, the radio waves used for triggering or scheduling may be sine waves, square waves, triangle waves, pulses, rectangular waves, or the like. In addition, the trigger signal may be a continuous wave or a non-continuous wave (that is, a certain period of interruption is allowed).

The trigger signal may be a signal defined in 3GPP standards, such as a SRS, a PUSCH, a PRACH, a PUCCH, a PDCCH, a PDSCH, or a PBCH, or may be a new signal.

In order to facilitate a better understanding of the embodiments of the present application, the categorization of zero-power-consumption terminals involved in the present application will be described.

Based on power sources and usages of zero-power-consumption terminals, zero-power-consumption terminals may be categorized into the following types.

### 1) Passive Zero-Power-Consumption Terminal

A zero-power-consumption terminal does not require built-in batteries. When a zero-power-consumption terminal approaches a network device (e.g., a reader/writer in an RFID system), the zero-power-consumption terminal is located within a near-field formed by radiation of antennas of the network device. Therefore, antennas of the zero-power-consumption terminal generates an induced current through electromagnetic induction, and the induced current drives a low-power-consumption chip circuit of the zero-power-consumption terminal, thereby implementing operations such as demodulating a forward link signal, and modulating a reverse link signal. For a backscatter link, the zero-power-consumption terminal uses an implementation of backscatter to transmit signals.

It can be seen that the passive zero-power-consumption terminal does not require a built-in battery to drive either a forward link or a reverse link, and is a true zero-power-consumption terminal.

The passive zero-power-consumption terminal does not require batteries, and the radio frequency circuit and baseband circuit are very simple. For example, the passive zero-power-consumption terminal does not require devices such as a low-noise amplifier (LNA), a power amplifier (PA), a crystal oscillator, and an analog-to-digital converter (ADC), and thus has many advantages such as small size, light weight, very low price, and a long service life.

### 2) Semi-Passive Zero-Power-Consumption Terminal

The semi-passive zero-power-consumption terminal itself does not have a conventional battery installed, but can use an RF power harvesting module to harvest radio wave power and store the harvested power in a power storage unit (e.g., a capacitor). The power storage unit may drive a low-power-consumption chip circuit of the zero-power-consumption terminal after the power storage unit obtains power, thereby implementing operations such as demodulating a forward link signal and modulating a reverse link signal. For a backscatter link, the zero-power-consumption terminal uses an implementation of backscatter to transmit signals.

It can be seen that the semi-passive zero-power-consumption terminal does not require a built-in battery to drive either the forward link or the reverse link. Although power stored in capacitors is used by the semi-passive zero-power-consumption terminal in operation, the power comes from radio power collected by the power harvesting module. Therefore, the semi-passive zero-power-consumption terminal is also a true zero-power-consumption terminal.

The semi-passive zero-power-consumption terminal inherits many advantages of the passive zero-power-consumption terminal, so the semi-passive zero-power-consumption terminal has many advantages such as small size, light weight, very low price and a long service life.

### 3) Active Zero-Power-Consumption Terminal

The zero-power-consumption terminal used in some scenarios may also be an active zero-power-consumption terminal, and such a terminal may have a built-in battery. The battery is used to drive a low-power chip circuit of the zero-power-consumption terminal, thereby implementing operations such as demodulating a forward link signal and modulating a reverse link signal. However, for a backscatter link, the zero-power-consumption terminal uses an implementation of backscatter to transmit signals. Therefore, the zero power consumption of such a terminal is mainly embodied in that signal transmission of the reverse link does not need the terminal's own power, but uses backscatter.

The active zero-power-consumption terminal has a built-in battery for supplying power to the RFID chip to increase the reading and writing distance of tags and improve the reliability of communication. Therefore, the active zero-power-consumption terminal may be applied in some scenarios with relatively high requirements for communication distance and reading delay.

In order to facilitate a better understanding of the embodiments of the present application, the cellular passive Internet of Things involved in the present application will be described.

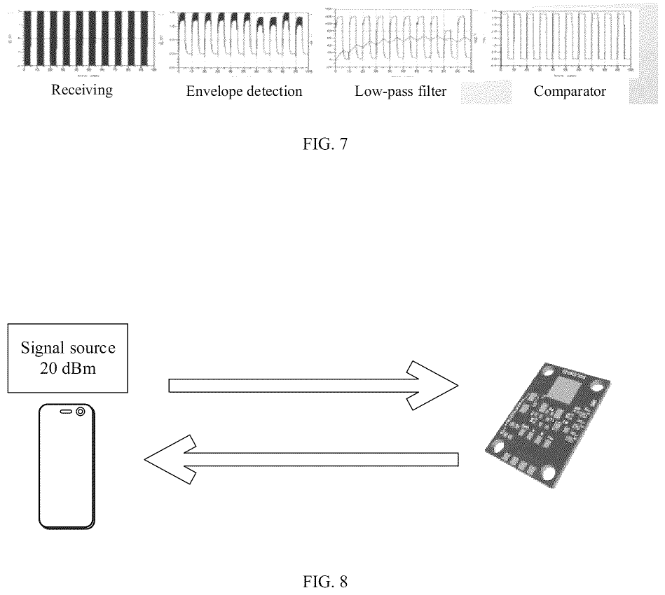

With the increase in 5G industry applications, the types of connected objects and application scenarios are increasing, and there will be higher requirements on the cost and power consumption of communication terminals. The application of battery-free, low-cost passive Internet of Things devices will become a key technology for cellular Internet of Things, which may enrich the types and number of terminals linked to the 5G network and truly realize interconnection of everything. Passive Internet of Things devices may be based on zero-power-consumption communication technology, e.g., the RFID technology, and may be extended on this basis to be suitable for cellular Internet of Things. As shown in FIG. 6, in NR idle state (NR Idle), the RF and baseband are still working. In low power-consumption (very low power), main RF modules sleep or turn off. In almost zero power-consumption (almost zero power), the on-off of a master RF module and baseband modules are determined by activating or waking up envelope detection of signals (from a slave RF module), and the envelope detection may be as shown in FIG. 7. In zero power-consumption (zero power), ambient radio frequency or other power is harvested to meet circuit consumption and communication needs.

In order to facilitate a better understanding of the embodiments of the present application, the problems solved by the present application will be described.

A receiving device (such as a CPE or a mobile phone) and a signal source (such as WiFi or Bluetooth source) are placed in the same location. The signal source transmits signals, and a voltage stabilizing source provides wireless power to a tag device. After texting, a maximum backscatter communication distance of the 20 dbm WiFi signal as the carrier is less than 1 meter, and the reflection coverage scenario is very limited, as shown in FIG. 8.

Here, calculation of the communication distance may be preliminarily calculated in the following way:
subtracting a backscatter loss (including insertion loss and antenna efficiency loss, e.g., 30 db) and a path loss (101 db free path loss at 3 meters) from a transmitter carrier power (e.g., 20 dBm) to obtain a signal of about −110 dbm at a receiving side.

The signal does not meet receiver sensitivity requirements (for example, −89 dbm/MHz is an actual measured minimum sensitivity requirement of Bluetooth for a mobile phone, and −97 dbm/MHz is the minimum sensitivity requirement of a Bluetooth signal for a CPE).

Based on the above problems, the present application proposes a solution for backscatter communication to solve the communication bottleneck of the reflection link, extend the reflection distance and expand practical application deployment.

The technical solutions of the present application are described in detail in the following through specific embodiments.

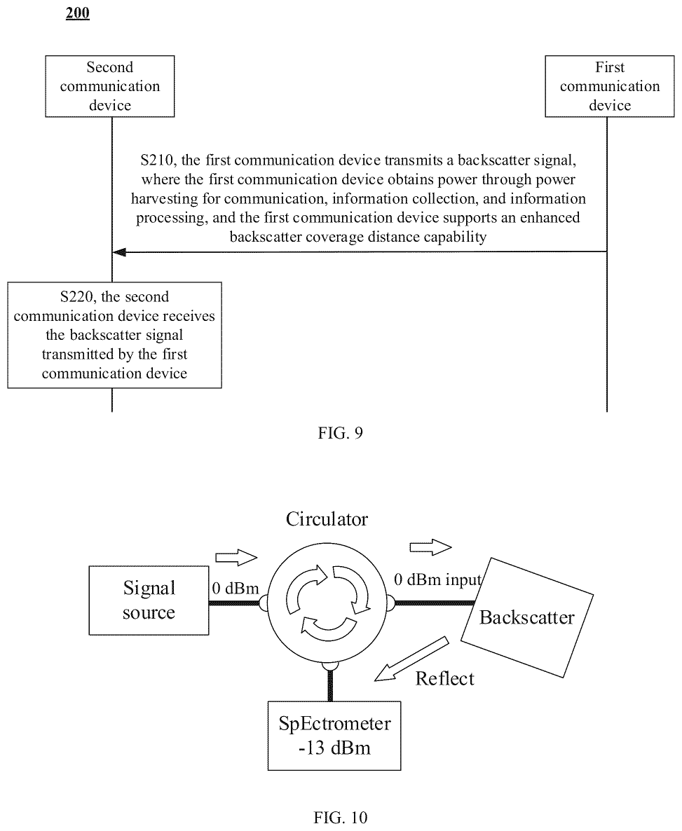

FIG. 9 is a schematic flowchart of a method 200 for wireless communication, in accordance with embodiments of the present application. As shown in FIG. 9, the method 200 for wireless communication may include at least part of the following content.

In S210, a first communication device transmits a backscatter signal, where the first communication device obtains power through power harvesting for communication, information collection, and information processing, and the first communication device supports an enhanced backscatter coverage distance capability.

In S220, a second communication device receives the backscatter signal transmitted by the first communication device.

In the embodiments of the present application, the first communication device supports the enhanced backscatter coverage distance capability, that is, the backscatter signal transmitted by the first communication device may have a greater coverage distance, in other words, the backscatter signal transmitted by the first communication device may be detected by the second communication device at a longer distance.

In some embodiments, a coverage distance of the backscatter signal transmitted by the first communication device is greater than or equal to a first threshold. The first threshold may be defined by a protocol, or the first threshold may be determined by the first communication device and the second communication device according to a negotiation therebetween, or the first threshold may be configured by a network device.

In the embodiments of the present application, the first communication device may be a zero-power-consumption device or tag device based on radio frequency power harvesting.

The present application mainly considers the scenario in which the zero-power-consumption device or tag device drives a backscattering transmitting signal through RF power harvesting, and other power supply manners, such as heat power, pressure, and light power, are not excluded. The power supply signal is related to the radio frequency capability of the tag device, and there is a minimum incident power requirement. The power supply signal and the carrier signal may be the same signal, or may be signals with the same frequency or different frequencies, which is depended on the radio frequency capability of the tag device (the number of channels that the tag device is capable of supporting).

In the embodiments of the present application, the backscatter communication may be communication between the first communication device and the second communication device. For example, the first communication device is a terminal device and the second communication device is a network device, that is, the communication between the first communication device and the second communication device may be uplink-downlink communication. As another example, the first communication device is one terminal device, and the second communication device is another terminal device, that is, the communication between the first communication device and the second communication device may be sidelink communication.

In a cellular network, the zero-power-consumption device needs to obtain power for communication through power harvesting due to a lack of batteries in the zero-power-consumption device. In one aspect, the zero-power-consumption device may harvest power from environmental power such as heat power, light power, or kinetic power; and in another aspect, the zero-power-consumption device may harvest power from radio frequency signals to obtain power for communication, and then perform corresponding communication processes based on backscattering. Typically, signals for power harvesting (i.e., energizing signals) may be provided by the network device or a dedicated power node. When communication is performed based on scheduling, the network device needs to provide control information and perform scheduling of information transmission, which may be referred to as a scheduling signal/trigger signal. The trigger signal and the power supply signal may be the same signal or two independent signals. When the zero-power-consumption device performs communication, a carrier capable of carrying the communication is required. The carrier may be a signal independent of the power supply signal and the trigger signal, or may be the same signal as the power supply signal or the trigger signal.

In the embodiments of the present application, the frequency bands of the power supply signal, the carrier signal, and the trigger signal may be completely different, completely the same, or partially the same. The power supply device continuously or intermittently sends power supply signals on a certain frequency band, and the zero-power-consumption device harvests power. After obtaining power, the zero-power-consumption device may perform corresponding communication processes, such as measurement, channel/signal reception, channel/signal transmission.

In some embodiments, that the first communication device supports the enhanced backscatter coverage distance capability is determined based on at least one of:
a sensitivity of a receiver of a second communication device, a receive antenna gain of the second communication device, a transmit power of a carrier signal of a third communication device, a transmit antenna gain of the third communication device, location information of the third communication device, angle information of a scanning antenna of the third communication device, an operating frequency of a carrier signal of the third communication device, an operating frequency of the backscatter signal, a frequency shifting capability supported by the first communication device, or a reflection capability of the first communication device.

Specifically, an power supply signal and/or trigger signal corresponding to the backscatter signal are transmitted by the third communication device.

In some embodiments, the second communication device is co-located with the third communication device.

In some embodiments, the second communication device and the third communication device are different devices. Alternatively, the second communication device and the third communication device are the same device.

In some embodiments, in a case where supporting of the enhanced backscatter coverage distance capability by the first communication device is determined based on at least the sensitivity of the receiver of the second communication device, the receiver of the second communication device supports an enhanced sensitivity. That is, the supporting of the enhanced backscatter coverage distance capability may be achieved by improving the sensitivity of the receiver of the second communication device, for example, the second communication device may be a mobile phone or other device with stronger reflection reception capability.

In a specific example, the receiver of the second communication device supports a sensitivity greater than or equal to a second threshold, so that the first communication device supports an enhanced backscatter coverage distance capability. The second threshold may be defined by a protocol, or the second threshold may be determined by the first communication device and the second communication device according to a negotiation therebetween, or the second threshold may be configured by a network device.

In some embodiments, the second communication device causes its receiver to support the enhanced sensitivity by reducing a reception bandwidth of the second communication device; and/or, the second communication device causes its receiver to support the enhanced sensitivity by reducing an insertion loss of a conductive circuit operating on a receive frequency band of the second communication device

For example, the receiver of the second communication device supports the enhanced sensitivity in the case where the reception bandwidth of the second communication device is less than or equal to a third threshold. The third threshold may be defined by a protocol, or the third threshold may be determined by the first communication device and the second communication device according to a negotiation therebetween, or the third threshold may be configured by a network device.

As another example, the receiver of the second communication device supports the enhanced sensitivity in the case where the insertion loss of the conductive circuit operating on the receive frequency band of the second communication device is less than or equal to a fourth threshold. The fourth threshold may be defined by a protocol, or the fourth threshold may be determined by the first communication device and the second communication device according to a negotiation therebetween, or the fourth threshold may be configured by a network device.

In some embodiments, in the case where the supporting of the enhanced backscatter coverage distance capability by the first communication device is determined based on at least the receive antenna gain of the second communication device, the second communication device supports an enhanced receive antenna gain. Specifically, the second communication device receives the backscatter signal using n receive (Rx) antennas, where n is a positive integer larger than or equal to 2.

For example, n equals to 4, i.e., the second communication device receives the backscatter signal using 4 Rx antennas.

In a specific example, the receive antenna gain of the second communication device is greater than or equal to a fifth threshold, so that the first communication device supports the enhanced backscatter coverage distance capability. The fifth threshold may be defined by a protocol, or the fifth threshold may be determined by the first communication device and the second communication device according to a negotiation therebetween, or the fifth threshold may be configured by a network device.

It should be noted that, as the receive antenna gain of the second communication device increases, the antenna directivity decreases, the reception angle decreases, and the restriction increases. Therefore, it is necessary to equally consider antenna directivity, reception angle, etc. to set a reasonable receive antenna gain.

In some embodiments, in the case where the supporting of the enhanced backscatter coverage distance capability by the first communication device is determined based on at least the transmit power of the carrier signal of the third communication device, the carrier signal of the third communication device corresponds to an enhanced transmit power.

In a specific example, in the case where the transmit power corresponding to the carrier signal of the third communication device is greater than or equal to a sixth threshold, the first communication device supports the enhanced backscatter coverage distance capability. The sixth threshold may be defined by a protocol, or the sixth threshold may be determined by the first communication device and the third communication device according to a negotiation therebetween, or the sixth threshold may be configured by a network device.

In some embodiments, in the case where the supporting of the enhanced backscatter coverage distance capability by the first communication device is determined based on at least the transmit antenna gain of the third communication device, the third communication device supports an enhanced transmit antenna gain. The transmit antenna gain includes a diversity gain or a beamforming gain.

In a specific example, in the case where the transmit antenna gain of the third communication device is greater than or equal to a seventh threshold, the first communication device supports the enhanced backscatter coverage distance capability. The seventh threshold may be defined by a protocol, or the seventh threshold may be determined by the first communication device and the second communication device according to a negotiation therebetween, or the seventh threshold may be configured by a network device.

In some embodiments, in the case where the supporting of the enhanced backscatter coverage distance capability by the first communication device is determined based on at least the location information of the third communication device, a distance between the third communication device and the first communication device is less than or equal to a first preset value.

In a specific example, in the case where the distance between the third communication device and the first communication device is less than or equal to the first preset value, the first communication device supports the enhanced backscatter coverage distance capability.

Optionally, the first preset value may be defined by a protocol, or the first preset value may be determined by the first communication device and the third communication device according to a negotiation therebetween, or the first preset value may be configured by a network device.

In a specific example, the position of the third communication device may be moved (i.e., approaching) to shorten a transmission distance of a carrier.

In some embodiments, in the case where the supporting of the enhanced backscatter coverage distance capability by the first communication device is determined based on at least the angle information of the scanning antenna of the third communication device, the maximum radiated power corresponding to the angle information of the scanning antenna of the third communication device is directed to the first communication device.

In a specific example, the scanning antenna of the third communication device is rotated such that the maximum radiated power is directed to the first communication device (e.g., a zero power tag device), such as a physically rotated directional beam sweep.

In some embodiments, in the case where the supporting of the enhanced backscatter coverage distance capability by the first communication device is determined based on at least the operating frequency of the carrier signal of the third communication device, or in case where supporting of the enhanced backscatter coverage distance capability by the first communication device is determined based on at least the operating frequency of the backscatter signal, the third communication device reduces the operating frequency of the carrier signal of the third communication device to a first frequency and modulates the operating frequency of the backscatter signal to a target frequency based on frequency multiplication information or frequency mixing information of the first frequency.

In a specific example, the carrier frequency is reduced to 900 MHz (such as combined with the power supply signal into the same signal), and the frequency multiplication or mixing signal of 900 MHz is used to achieve the modulation of the frequency to a predetermined target frequency of the backscatter signal, such as 2.4 GHz, so as to reduce downlink path loss.

In some embodiments, in the case where the supporting of the enhanced backscatter coverage distance capability by the first communication device is determined based on at least the frequency shift capability supported by the first communication device, the frequency shift capability supported by the first communication device includes increasing or decreasing a frequency with a first frequency modulation interval, or the frequency shift capability supported by the first communication device includes increasing or decreasing a frequency with a plurality of frequency modulation intervals.

In some embodiments, the first frequency modulation interval is defined by a protocol, or the first frequency modulation interval is configured by a network device. For example, the first frequency modulation interval is one of following: 10 MHz, 15 MHz, 20 MHz, 30 MHz, or 50 MHz. In a specific example, the first communication device may multiplex a set of oscillator circuits, for example, by switching a switch of the oscillator circuits to control a downward or upward shift of 10 MHz at a time.

In some embodiments, the plurality of frequency modulation intervals are defined by a protocol, or the plurality of frequency modulation intervals are configured by a network device. For example, the plurality of frequency modulation intervals are 40 MHz, 20 MHz, 10 MHz, 5 MHz, and the like. In a specific example, the first communication device may support a plurality of sets of hardware circuits, and the plurality of sets of hardware circuits correspond to a plurality of frequency modulation intervals, respectively.

In some embodiments, an operating frequency of the first communication device is modulated to a Bluetooth broadcast signal frequency from a wireless fidelity (WiFi) signal through frequency-shift keying modulation (FSK), or the operating frequency of the first communication device is modulated to a Bluetooth broadcast signal frequency from a cellular network signal through FSK.

For example, the operating frequency of the first communication device is modulated (downward shift in frequency) to a Bluetooth broadcast signal (e.g., 2402 MHz channel 37) from a WiFi signal (e.g., a 2412 MHz channel) through FSK.

As another example, the operating frequency of the first communication device is modulated (upward shift in frequency) to a Bluetooth broadcast signal (e.g., 2402 MHz channel 37) from an LTE signal (e.g., with a 2359 MHz center frequency and a 1.4 MHz bandwidth) through FSK.

In some embodiments, in the case where the supporting of the enhanced backscatter coverage distance capability by the first communication device is determined based on at least the reflection capability of the first communication device, the first communication device supports an enhanced reflection capability. For example, the first communication device may be caused to support the enhanced reflectivity by hardware optimization.

In a specific example, in the case where the reflection capability of the first communication device is greater than or equal to the eighth threshold, the first communication device supports the enhanced backscatter coverage distance capability. The eighth threshold may be defined by a protocol, or the eighth threshold may be determined by the first communication device and the second communication device according to a negotiation therebetween, or the eighth threshold may be configured by a network device.

In some embodiments, the first communication device causes itself to support the enhanced reflection capability by reducing an insertion loss of a conductive circuit of the first communication device, or the first communication device causes itself to support the enhanced reflection capability by reducing an insertion loss corresponding to a carrier frequency of the first communication device. In a specific example, a schematic diagram showing backscattering may be shown in FIG. 10. The first communication device may select a low insertion loss device, or the first communication device may select a carrier frequency with a low insertion loss.

The insertion loss of the conduction circuit of the first communication device is related to the frequency, the oscillator, or the like.

In some embodiments, the first communication device is caused to support the enhanced reflection capability by increasing an antenna area of a built-in antenna of the first communication device, and/or the first communication device is caused to support the enhanced reflection capability by increasing a reflection cross section of the built-in antenna of the first communication device, and/or the first communication device is caused to support the enhanced reflection capability by increasing an efficiency of the built-in antenna of the first communication device.

Specifically, in one example, in the case where the antenna area of the built-in antenna of the first communication device is greater than or equal to a ninth threshold, the first communication device supports the enhanced reflection capability.

Specifically, in another example, in the case where the reflection cross section of the built-in antenna of the first communication device is greater than or equal to a tenth threshold, the first communication device supports the enhanced reflection capability.

Specifically, in yet another example, in the case where the efficiency of the built-in antenna of the first communication device is greater than or equal to an eleventh threshold, the first communication device supports the enhanced reflection capability.

In some embodiments, an external antenna of the first communication device employs a directional antenna, and the first communication device causes itself to support the enhanced reflection capability by increasing a gain of the directional antenna.

Therefore, in the embodiments of the present application, the first communication device supports the enhanced backscatter coverage distance capability, which may improve the backscatter coverage distance of the first communication device. The communication bottleneck of the reflection link may be solved, the reflection distance is extended, and practical application deployment is expanded.

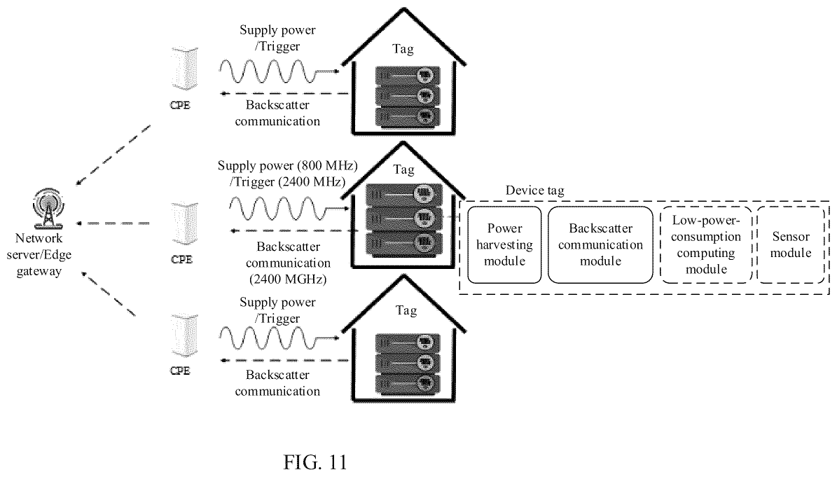

Hereinafter, the technical solution of the present application will be described in detail with reference to specific embodiments. Specifically, the first communication device is a tag, and the second communication device and the third communication device are CPEs, as shown in FIG. 11.

The CPEs acts as readers/writers to trigger/read the tag, and also act as fixed or mobile collection points to return information of the tag. Regarding transmitting (Tx), the CPEs transmit 800 MHz/900 MHz signals to provide wireless power supply, and transmit a 2.4 GHz continuous wave as a carrier signal. Regarding receiving (Rx), the CPEs simultaneously receive a reflected 2.4 GHZ Bluetooth signal, which contains the information carried by the tag. The CPEs may support the transmission of a 2400 MHz signal on frequency band of WiFi or LTE B40 or NR n40. The WiFi or Bluetooth channel is limited to a maximum of 20 dBm transmit power, and the operating frequency is above 2402 MHz. B40 or n40 is limited to a maximum of 23-26 dBm transmit power, and the operating frequency is below 2400 MHz. That is to say, 2.4 GHz carriers in different signal modes (WiFi or LTE or NR) are provided.

The tag supports wireless charging in a certain frequency band of 800 MHz or 900 MHz or 2.4 GHz, and supports backscatter (for reflecting a Bluetooth broadcast signal or a WiFi signal) in a certain frequency band of 2.4 GHz (such as Bluetooth broadcast signal 37 near 2402 MHz, or WiFi signal at 2412 MHz). When charging at 800 MHz and reflecting at 2.4 GHz, the charging power supply and the carrier signal are different signals. When the same CPE device provides charging and carriers, in the case where the power supply distance of 800 MHz is not limited (for example, supporting a distance of 4 meters), the reflection distance of 2.4 GHz (less than 1 meter) is the focus of the enhancement that is to be solved in the embodiment.

For the specific solutions, the following Manner 1 to Manner 5 may be applied to enable the tag to support the enhanced backscatter coverage distance capability.

Manner 1: reflection reception enhancement of the CPE, includes:
improving the sensitivity of CPE receiver, for example, reducing the receiving bandwidth, such as reducing the circuit insertion loss on the receiving frequency band; and
improving Rx antenna gain of the CPE, for example, employing multi-antenna 4 Rx reception.

Manner 2: transmission enhancement of the CPE, includes:
increasing the transmit power of the 2.4 GHz WiFi carrier signal, and increasing the transmit antenna gain (diversity gain or beamforming gain), to obtain a signal within a range of 20 dBm+2 dbi/8 dbi;
increasing the transmit power of the 2.4 GHz LTE carrier signal, and increasing the transmit antenna gain (diversity gain or beamforming gain), to obtain a signal within a range of 23 dBm+5 dbi; and
moving the position of the transmitting source (approaching), or rotate the scanning antenna so that the maximum radiated power is directed to the zero-power-consumption tag device, such as a physically rotated directional beam sweep.

Manner 3: operating frequency selection, includes:
reducing the carrier frequency to 900 MHz (such as combining the carrier with the power supply signal into the same signal), and using frequency multiplication or mixing signal of 900 MHz to achieve the modulation of the frequency to a predetermined target frequency of the backscatter signal, such as 2.4 GHz, so as to reduce downlink path loss.

Manner 4: frequency selection and transmit power increase, requires that:
the tag supports a capability of shifting a variety of frequencies.

For example, the capability may be multiplexing a set of oscillator circuits, that is, have the same frequency modulation interval, but supports different frequency modulation directions, such as by switching a switch of the oscillator circuits to control a downward or upward shift of 10 MHz at a time. In another example, the capability may also be different frequency modulation intervals (such as supported by a plurality of sets of hardware circuits), e.g., frequency offsets of 40 MHz, 20 MHz, 10 MHz, 5 MHz, etc.

In Example 1, a WiFi signal (2412 MHz channel) is modulated (downward frequency shift) to a Bluetooth broadcast signal frequency (2402 MHz channel 37) through FSK.

In Example 2, an LTE signal (e.g., with a 2395 MHz center frequency, a 1.4 MHz bandwidth) is modulated (upward frequency shift) to a Bluetooth broadcast signal frequency (2402 MHz channel 37) through FSK.

In Manner 5, reflection capability is optimized (hardware design optimization).

Specifically, in one example, the insertion loss of the conductive circuit (related to frequency and oscillator) is optimized and reduced, for example, a low insertion loss device or a carrier frequency with a low insertion loss (assuming that the reflection frequency is fixed for the target) is selected, and the gain of the reflection antenna is improved or the attenuation of the reflection antenna is reduced (to improve the antenna efficiency).

Specifically, in another example, for a built-in antenna, the antenna area is increased, the reflection cross section is increased, and the antenna efficiency is improved; and/or for an external antenna, a directional antenna with a large gain is employed.

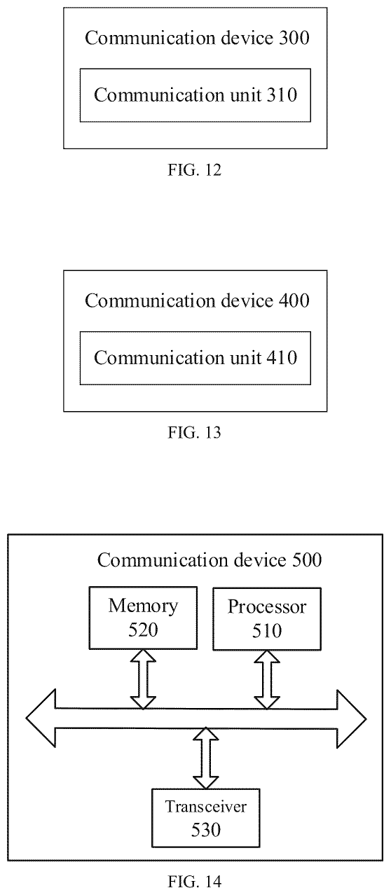

With reference to FIGS. 9 to 11, the method embodiments of the present application are described in detail in the above. In the following, the device embodiments of the present application will be described in detail with reference to FIGS. 12 and 13. It should be understood that the device embodiments correspond to the method embodiments, and the device embodiments may refer the similar description in the method embodiments.

FIG. 12 shows a schematic block diagram of a communication device 300 according to an embodiment of the present application. The communication device 300 is a first communication device, and as shown in FIG. 12, the communication device 300 includes:
a communication unit 310 configured to transmit a backscatter signal;
where the first communication device obtains power through power harvesting for communication, information collection, and information processing, and the first communication device supports an enhanced backscatter coverage distance capability.

In some embodiments, that the first communication device supports the enhanced backscatter coverage distance capability is determined based on at least one of:
a sensitivity of a receiver of the second communication device, a receive antenna gain of the second communication device, a transmit power of a carrier signal of the third communication device, a transmit antenna gain of the third communication device, position information of the third communication device, angle information of a scanning antenna of the third communication device, an operating frequency of the carrier signal of the third communication device, an operating frequency of the backscatter signal, a frequency shift capability supported by the first communication device, a reflection capability of the first communication device;
where a receiving terminal of the backscatter signal is the second communication device, and a power supply signal and/or trigger signal corresponding to the backscatter signal are transmitted by the third communication device.

In some embodiments, in the case where the supporting of the enhanced backscatter coverage distance capability by the first communication device is determined based on at least the sensitivity of the receiver of the second communication device, the receiver of the second communication device supports an enhanced sensitivity.

In some embodiments, the second communication device causes its receiver to support the enhanced sensitivity by reducing a reception bandwidth of the second communication device; and/or, the second communication device causes its receiver to support the enhanced sensitivity by reducing an insertion loss of a conductive circuit operating on a receive frequency band of the second communication device.

In some embodiments, in the case where the supporting of the enhanced backscatter coverage distance capability by the first communication device is determined based on at least the receive antenna gain of the second communication device, the second communication device supports an enhanced receive antenna gain.

In some embodiments, the second communication device receives the backscatter signal using n receive (Rx) antennas, and n is a positive integer larger than or equal to 2.

In some embodiments, in the case where the supporting of the enhanced backscatter coverage distance capability by the first communication device is determined based on at least the transmit power of the carrier signal of the third communication device, the carrier signal of the third communication device corresponds to an enhanced transmit power.

In some embodiments, in the case where the supporting of the enhanced backscatter coverage distance capability by the first communication device is determined based on at least the transmit antenna gain of the third communication device, the third communication device supports an enhanced transmit antenna gain;
where the transmit antenna gain includes a diversity gain or a beamforming gain.

In some embodiments, in the case where the supporting of the enhanced backscatter coverage distance capability by the first communication device is determined based on at least the location information of the third communication device, a distance between the third communication device and the first communication device is less than or equal to a first preset value.

In some embodiments, in the case where the supporting of the enhanced backscatter coverage distance capability by the first communication device is determined based on at least the angle information of the scanning antenna of the third communication device, a maximum radiated power corresponding to the angle information of the scanning antenna of the third communication device is directed to the first communication device.

In some embodiments, in the case where the supporting of the enhanced backscatter coverage distance capability by the first communication device is determined based on at least the operating frequency of the carrier signal of the third communication device, or in case where supporting of the enhanced backscatter coverage distance capability by the first communication device is determined based on at least the operating frequency of the backscatter signal, the third communication device reduces the operating frequency of the carrier signal of the third communication device to a first frequency and modulates the operating frequency of the backscatter signal to a target frequency based on frequency multiplication information or frequency mixing information of the first frequency.

In some embodiments, in the case where the supporting of the enhanced backscatter coverage distance capability by the first communication device is determined based on at least the frequency shift capability supported by the first communication device, the frequency shift capability supported by the first communication device includes increasing or decreasing a frequency with a first frequency modulation interval, or the frequency shift capability supported by the first communication device includes increasing or decreasing a frequency with a plurality of frequency modulation intervals.

In some embodiments, the first frequency modulation interval is defined by a protocol, or the first frequency modulation interval is configured by a network device.

In some embodiments, the plurality of frequency modulation intervals are defined by a protocol, or the plurality of frequency modulation intervals are configured by a network device.

In some embodiments, an operating frequency of the first communication device is modulated from a wireless fidelity (WiFi) signal to a Bluetooth broadcast signal frequency through frequency shift keying modulation (FSK), or the operating frequency of the first communication device is modulated from a cellular network signal to a Bluetooth broadcast signal frequency through FSK.

In some embodiments, in the case where the supporting of the enhanced backscatter coverage distance capability by the first communication device is determined based on at least the reflection capability of the first communication device, the first communication device supports an enhanced reflection capability.

In some embodiments, the first communication device causes itself to support the enhanced reflection capability by reducing an insertion loss of a conductive circuit of the first communication device, or the first communication device causes itself to support the enhanced reflection capability by reducing an insertion loss corresponding to a carrier frequency of the first communication device.

In some embodiments, the first communication device is caused to support the enhanced reflection capability by increasing an antenna area of a built-in antenna of the first communication device, and/or the first communication device is caused to support the enhanced reflection capability by increasing a reflection cross section of the built-in antenna of the first communication device, and/or the first communication device is caused to support the enhanced reflection capability by increasing an efficiency of the built-in antenna of the first communication device;
and/or,
an external antenna of the first communication device employs a directional antenna, and the first communication device is caused to support the enhanced reflection capability by increasing a gain of the directional antenna.

In some embodiments, the second communication device is co-located with the third communication device.

In some embodiments, the second communication device and the third communication device are different devices; or,
the second communication device and the third communication device are a same device.

In some embodiments, the above-mentioned communication unit may be a communication interface or a transceiver, or an input/output interface of a communication chip or a system on chip. The above-mentioned processing unit may be singular or plural in quantity.

It should be understood that the communication device 300 according to the embodiment of the present application may correspond to the first communication device in the method embodiments of the present application, and the above-mentioned and other operations and/or functions of various units in the communication device 300 are for implementing corresponding processes of the first communication device in the method 200 shown in FIG. 9, which will not be repeated herein for brevity.

FIG. 13 shows a schematic block diagram of a communication device 400 according to an embodiment of the present application. The communication device 400 is a second communication device, and as shown in FIG. 13, the communication device 400 includes:
a communication unit 410 configured to receive a backscatter signal transmitted by the first communication device;
where the first communication device obtains power through power harvesting for communication, information collection, and information processing, and the first communication device supports an enhanced backscatter coverage distance capability.

In some embodiments, that the first communication device supports the enhanced backscatter coverage distance capability is determined based on at least one of following:
a sensitivity of a receiver of the second communication device, a receive antenna gain of the second communication device, a transmit power of a carrier signal of a third communication device, a transmit antenna gain of the third communication device, location information of the third communication device, angle information of a scanning antenna of the third communication device, an operating frequency of a carrier signal of the third communication device, an operating frequency of the backscatter signal, a frequency shifting capability supported by the first communication device, or a reflection capability of the first communication device;
where a power supply signal and/or trigger signal corresponding to the backscatter signal are transmitted by the third communication device.

In some embodiments, in the case where the supporting of the enhanced backscatter coverage distance capability by the first communication device is determined based on at least the sensitivity of the receiver of the second communication device, the receiver of the second communication device supports an enhanced sensitivity.

In some embodiments, the second communication device causes its receiver to support the enhanced sensitivity by reducing a reception bandwidth of the second communication device; and/or, the second communication device causes its receiver to support the enhanced sensitivity by reducing an insertion loss of a conductive circuit operating on a receive frequency band of the second communication device.

In some embodiments, in the case where the supporting of the enhanced backscatter coverage distance capability by the first communication device is determined based on at least the receive antenna gain of the second communication device, the second communication device supports an enhanced receive antenna gain.

In some embodiments, the second communication device receives the backscatter signal using n receive (Rx) antennas, and n is a positive integer larger than or equal to 2.

In some embodiments, in the case where the supporting of the enhanced backscatter coverage distance capability by the first communication device is determined based on at least the transmit power of the carrier signal of the third communication device, the carrier signal of the third communication device corresponds to an enhanced transmit power.

In some embodiments, in the case where the supporting of the enhanced backscatter coverage distance capability by the first communication device is determined based on at least the transmit antenna gain of the third communication device, the third communication device supports an enhanced transmit antenna gain;
where the transmit antenna gain includes a diversity gain or a beamforming gain.

In some embodiments, in the case where the supporting of the enhanced backscatter coverage distance capability by the first communication device is determined based on at least the location information of the third communication device, a distance between the third communication device and the first communication device is less than or equal to a first preset value.

In some embodiments, in the case where the supporting of the enhanced backscatter coverage distance capability by the first communication device is determined based on at least the angle information of the scanning antenna of the third communication device, a maximum radiated power corresponding to the angle information of the scanning antenna of the third communication device is directed to the first communication device.

In some embodiments, in the case where the supporting of the enhanced backscatter coverage distance capability by the first communication device is determined based on at least the operating frequency of the carrier signal of the third communication device, or in case where supporting of the enhanced backscatter coverage distance capability by the first communication device is determined based on at least the operating frequency of the backscatter signal, the third communication device reduces the operating frequency of the carrier signal of the third communication device to a first frequency and modulates the operating frequency of the backscatter signal to a target frequency based on frequency multiplication information or frequency mixing information of the first frequency.

In some embodiments, in the case where the supporting of the enhanced backscatter coverage distance capability by the first communication device is determined based on at least the frequency shift capability supported by the first communication device, the frequency shift capability supported by the first communication device includes increasing or decreasing a frequency with a first frequency modulation interval, or the frequency shift capability supported by the first communication device includes increasing or decreasing a frequency with a plurality of frequency modulation intervals.

In some embodiments, the first frequency modulation interval is defined by a protocol, or the first frequency modulation interval is configured by a network device.

In some embodiments, the plurality of frequency modulation intervals are defined by a protocol, or the plurality of frequency modulation intervals are configured by a network device.

In some embodiments, an operating frequency of the first communication device is modulated from a wireless fidelity (WiFi) signal to a Bluetooth broadcast signal frequency through frequency shift keying modulation (FSK), or the operating frequency of the first communication device is modulated from a cellular network signal to a Bluetooth broadcast signal frequency through FSK.

In some embodiments, in a case where supporting of the enhanced backscatter coverage distance capability by the first communication device is determined based on at least the reflection capability of the first communication device, the first communication device supports an enhanced reflection capability.

In some embodiments, the first communication device causes itself to support the enhanced reflection capability by reducing an insertion loss of a conductive circuit of the first communication device, or the first communication device causes itself to support the enhanced reflection capability by reducing an insertion loss corresponding to a carrier frequency of the first communication device.

In some embodiments, the first communication device is caused to support the enhanced reflection capability by increasing an antenna area of a built-in antenna of the first communication device, and/or the first communication device is caused to support the enhanced reflection capability by increasing a reflection cross section of the built-in antenna of the first communication device, and/or the first communication device is caused to support the enhanced reflection capability by increasing an efficiency of the built-in antenna of the first communication device;
and/or,
an external antenna of the first communication device employs a directional antenna, and the first communication device is caused to support the enhanced reflection capability by increasing a gain of the directional antenna.

In some embodiments, the second communication device is co-located with the third communication device.

In some embodiments, the second communication device and the third communication device are different devices; or,
the second communication device and the third communication device are a same device.

In some embodiments, the above-mentioned communication unit may be a communication interface or a transceiver, or an input/output interface of a communication chip or a system on chip. The above-mentioned processing unit may be singular or plural in quantity.

It should be understood that the communication device 400 according to the embodiment of the present application may correspond to the first communication device in the method embodiments of the present application, and the above-mentioned and other operations and/or functions of various units in the communication device 400 are for implementing corresponding processes of the first communication device in the method 200 shown in FIG. 9, which will not be repeated herein for brevity.

FIG. 14 is a schematic block diagram of a communication device 500 according to an embodiment of the present application. The communication device 500 shown in FIG. 14 includes a processor 510, and the processor 510 is capable of calling and running a computer program from a memory to implement the methods in the embodiments of the present application.

In some embodiments, as shown in FIG. 14, the communication device 500 may further include a memory 520. The processor 510 may call and run a computer program from the memory 520 to implement the methods in the embodiments of the present application.

The memory 520 may be a separate device independent of the processor 510, or may be integrated in the processor 510.

In some embodiments, as shown in FIG. 14, the communication device 500 may further include a transceiver 530, and the processor 510 may control the transceiver 530 to communicate with another device. Specifically, the transceiver 530 may send information or data to another device or receive information or data sent by another device.

The transceiver 530 may include a transmitter and a receiver. The transceiver 530 may further include an antenna, and the antenna may be singular or plural in quantity.

In some embodiments, the communication device 500 may specifically be the first communication device according to the embodiments of the present application, and the communication device 500 may implement corresponding processes implemented by the first communication device in various methods in the embodiments of the present application, which will not be repeated here for brevity.

In some embodiments, the communication device 500 may specifically be the second communication device according to the embodiments of the present application, and the communication device 500 may implement corresponding processes implemented by the second communication device in various methods in the embodiments of the present application, which will not be repeated here for brevity.

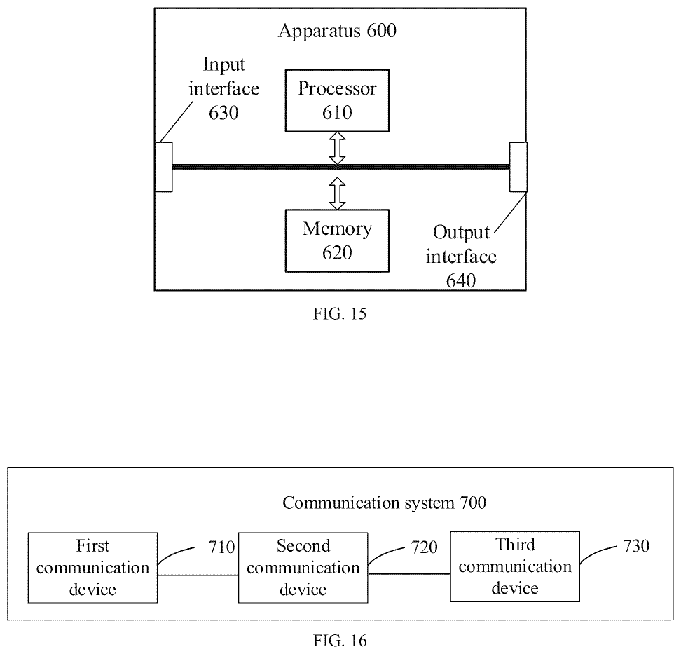

FIG. 15 is a schematic block diagram of an apparatus according to an embodiment of the present application. The apparatus 600 shown in FIG. 15 includes a processor 610 that is capable of calling and running a computer program from a memory to implement the methods in the embodiments of the present application.

In some embodiments, as shown in FIG. 15, the apparatus 600 may further include a memory 620. The processor 610 may call and run a computer program from the memory 620 to implement the methods in the embodiments of the present application.

The memory 620 may be a separate device independent of the processor 610, or may be integrated in the processor 610.

In some embodiments, the apparatus 600 may further include an input interface 630. The processor 610 may communicate with another device or chip by controlling the input interface 630. Specifically, the processor 610 may obtain information or data sent by another device or chip.

In some embodiments, the apparatus 600 may further include an output interface 640. The processor 610 may communicate with another device or chip by controlling the output interface 640. Specifically, the processor 610 may output information or data to another device or chip.

In some embodiments, the apparatus may be applied to the first communication device in the embodiments of the present application, and the apparatus may implement corresponding processes implemented by the first communication device in various methods in the embodiments of the present application, which will not be repeated here for brevity.

In some embodiments, the apparatus may be applied to the second communication device in the embodiments of the present application, and the apparatus may implement corresponding processes implemented by the second communication device in various methods in the embodiments of the present application, which will not be repeated here for brevity.

In some embodiments, the apparatus mentioned in the embodiments of the present application may also be a chip. For example, it may be a system-level chip, a system chip, a chip system, or a system on chip.

FIG. 16 is a schematic block diagram of a communication system 700 according to an embodiment of the present application. As shown in FIG. 16, the communication system 700 includes a first communication device 710, a second communication device 720, and a third communication device 730.

The first communication device 710 may be configured to implement the corresponding functions implemented by the first communication device in the above-mentioned methods, the second communication device 720 may be configured to implement the corresponding functions implemented by the second communication device in the above-mentioned methods, and the third communication device 730 may be configured to implement the corresponding functions implemented by the third communication device in the above-mentioned methods, which will not be repeated herein for brevity.

It should be understood that the processor in the embodiments of the present disclosure may be an integrated circuit chip with a capability for processing signals. In an implementation process, various steps of the method embodiments described above may be completed through an integrated logic circuit of hardware in a processor or instructions in a form of software. The processor described above may be a general purpose processor, a digital signal processor (DSP), an application specific integrated circuit (ASIC), a field programmable gate array (FPGA), or another programmable logic device, a discrete gate or transistor logic device, or a discrete hardware component. The processor may implement various methods, steps, and logic block diagrams disclosed in the embodiments of the present disclosure. The general purpose processor may be a microprocessor or the processor may be any conventional processor. The steps of the method disclosed with reference to the embodiment of the present disclosure may be directly implemented by a hardware decoding processor, or may be executed and completed by a combination of hardware and software modules in a decoding processor. The software modules may be located in a storage medium commonly used in the art, such as a random access memory, a flash memory, a read-only memory, a programmable read-only memory or an electrically erasable programmable memory, or a register. The storage medium is located in a memory, and the processor reads information in the memory and completes the steps of the above methods in combination with hardware of the processor.

It will be appreciated that the memory in the embodiments of the present disclosure may be a volatile or non-volatile memory, or may include both volatile and non-volatile memories. The non-volatile memory may be a read-only memory (ROM), a programmable ROM (PROM), an erasable PROM (EPROM), electrically EPROM (EEPROM), or a flash memory. The volatile memory may be a random access memory (RAM) which serves as an external cache. As an example, but not as a limitation, many forms of RAMs are available, such as a static RAM (SRAM), a dynamic RAM (DRAM), a synchronous DRAM (SDRAM), a double data rate SDRAM (DDR SDRAM), an enhanced SDRAM (ESDRAM), a synchlink DRAM (SLDRAM), and a direct rambus RAM (DR RAM). It should be noted that the memories of the systems and methods described herein are intended to include, but are not limited to, these and any other suitable types of memories.

It should be understood that the above memories are described as examples rather than limitations. For example, the memory in the embodiments of the present disclosure may be a static RAM (SRAM), a dynamic RAM (DRAM), a synchronous DRAM (SDRAM), a double data rate SDRAM (DDR SDRAM), an enhanced SDRAM (ESDRAM), a synchlink DRAM (synch link DRAM, SLDRAM), or a direct rambus RAM (DR RAM). That is to say, the memories in the embodiments of the present disclosure are intended to include, but are not limited to, these and any other suitable types of memories.

The embodiments of the present disclosure further provide a non-transitory computer-readable storage medium configured to store a computer program.

In some embodiments, the non-transitory computer-readable storage medium may be applied to the first communication device in the embodiments of the present application, and the computer program causes a computer to perform corresponding processes implemented by the first communication device in various methods in the embodiments of the present application, which will not be repeated here for brevity.

In some embodiments, the non-transitory computer-readable storage medium may be applied in the second terminal device of the embodiments of the present application, and the computer program causes a computer to perform corresponding processes implemented by the second terminal device in various methods in the embodiments of the present application, which will not be repeated here for brevity.

The embodiments of the present disclosure further provide a computer program product including computer program instructions.

In some embodiments, the computer program product may be applied to the first communication device in the embodiments of the present application, and the computer program instructions cause a computer to perform corresponding processes implemented by the first communication device in various methods in the embodiments of the present application, which will not be repeated here for brevity.

In some embodiments, the computer program product may be applied to the second communication device in the embodiments of the present application, and the computer program instructions cause a computer to perform corresponding processes implemented by the second communication device in various methods in the embodiments of the present application, which will not be repeated here for brevity.

The embodiments of the present disclosure further provide a computer program.

In some embodiments, the computer program may be applied to the first communication device in the embodiments of the present application. When running on a computer, the computer program causes the computer to perform corresponding processes implemented by the first communication device in various methods in the embodiments of the present application, which will not be repeated here for brevity.

In some embodiments, the computer program may be applied to the second communication device in the embodiments of the present application. When running on a computer, the computer program causes the computer to perform corresponding processes implemented by the second communication device in various methods in the embodiments of the present application, which will not be repeated here for brevity.

Those of ordinary skills in the art will recognize that units and algorithm steps of various examples described in connection with the embodiments disclosed herein may be implemented in electronic hardware, or a combination of computer software and electronic hardware. Whether these functions are implemented in a form of hardware or software depends on a specific application and a design constraint of a technical solution. Those skilled in the art may use different methods to implement the described functions for each specific application, but such implementation should not be considered to be beyond the scope of the present disclosure.

Those skilled in the art may clearly understand that for convenience and conciseness of description, specific working processes of the systems, devices/apparatuses, and units described above may refer to corresponding processes in the aforementioned method embodiments, and details will not be repeated here.

In several embodiments according to the present disclosure, it should be understood that the disclosed systems, devices/apparatuses, and methods may be implemented in other ways. For example, the device/apparatus embodiments described above are only illustrative, for example, the division of the units is only a logical function division, and there may be other division manners in actual implementation. For example, multiple units or components may be combined or integrated into another system, or some features may be ignored or not executed. In addition, coupling or direct coupling or communication connection shown or discussed between each other, which may be indirect coupling or communication connection between the devices or units via some interfaces, may be electrical, mechanical, or in other forms.

The units described as separate components may be or may be not physically separated, and the component shown as a unit may be or may be not a physical unit, i.e., it may be located in one place or may be distributed on multiple network units. Some or all of units may be selected according to actual needs to achieve purposes of technical solutions of the embodiments.

In addition, various functional units in various embodiments of the present disclosure may be integrated in one processing unit, or various units may be physically present separately, or two or more units may be integrated in one unit.

The functions, if implemented in a form of software functional units and sold or used as an independent product, may be stored in a computer-readable storage medium. For such understanding, the technical solutions of the present application, in essence, or the part which contributes to the prior art, or part of the technical solutions, may be embodied in the form of a software product, in which the computer software product is stored in one storage medium including a number of instructions for causing one computer device (which may be a personal computer, a server, or a network device) to perform all or some of the steps of the methods according to various embodiments of the present application. The aforementioned storage media includes various media capable of storing program codes, such as a U disk, a mobile hard disk, a read-only memory (ROM), a random access memory (RAM), a magnetic disk, an optical disk, and the like.

The foregoing are merely specific embodiments of the present disclosure, but the protection scope of the present disclosure is not limited thereto. Any person skilled in the art may readily conceive variations or substitutions within the technical scope disclosed by the present disclosure, which should be included within the protection scope of the present disclosure. Therefore, the protection scope of the present disclosure shall be subject to the protection scope of the claims.

What is claimed is:

1. A method for wireless communication, comprising:
transmitting, by a first communication device, a backscatter signal;
wherein the first communication device obtains power through power harvesting for communication, information collection and information processing, and the first communication device supports an enhanced backscatter coverage distance capability.

2. The method according to claim 1, wherein
that the first communication device supports the enhanced backscatter coverage distance capability is determined based on at least one of following:
a sensitivity of a receiver of a second communication device, a receive antenna gain of the second communication device, a transmit power of a carrier signal of a third communication device, a transmit antenna gain of the third communication device, location information of the third communication device, angle information of a scanning antenna of the third communication device, an operating frequency of a carrier signal of the third communication device, an operating frequency of the backscatter signal, a frequency shifting capability supported by the first communication device, or a reflection capability of the first communication device;
wherein a receiving terminal of the backscatter signal is the second communication device, and a power supply signal and/or trigger signal corresponding to the backscatter signal are transmitted by the third communication device.

3. The method according to claim 2, wherein
in a case where supporting of the enhanced backscatter coverage distance capability by the first communication device is determined based on at least the sensitivity of the receiver of the second communication device, the receiver of the second communication device supports an enhanced sensitivity.

4. The method according to claim 3, wherein
the second communication device causes its receiver to support the enhanced sensitivity by reducing a reception bandwidth of the second communication device; and/or,
the second communication device causes its receiver to support the enhanced sensitivity by reducing an insertion loss of a conductive circuit operating on a receive frequency band of the second communication device.

5. The method according to claim 2, wherein
in a case where supporting of the enhanced backscatter coverage distance capability by the first communication device is determined based on at least the receive antenna gain of the second communication device, the second communication device supports an enhanced receive antenna gain.

6. The method according to claim 2, wherein
in a case where supporting of the enhanced backscatter coverage distance capability by the first communication device is determined based on at least the transmit antenna gain of the third communication device, the third communication device supports an enhanced transmit antenna gain;
wherein the transmit antenna gain comprises a diversity gain or a beamforming gain.

7. The method according to claim 2, wherein
in a case where supporting of the enhanced backscatter coverage distance capability by the first communication device is determined based on at least the location information of the third communication device, a distance between the third communication device and the first communication device is less than or equal to a first preset value.

8. A method for wireless communication, comprising:
receiving, by a second communication device, a backscatter signal transmitted by a first communication device;
wherein the first communication device obtains power through power harvesting for communication, information collection and information processing, and the first communication device supports an enhanced backscatter coverage distance capability.

9. The method according to claim 8, wherein
that the first communication device supports the enhanced backscatter coverage distance capability is determined based on at least one of following:
a sensitivity of a receiver of the second communication device, a receive antenna gain of the second communication device, a transmit power of a carrier signal of a third communication device, a transmit antenna gain of the third communication device, location information of the third communication device, angle information of a scanning antenna of the third communication device, an operating frequency of a carrier signal of the third communication device, an operating frequency of the backscatter signal, a frequency shifting capability supported by the first communication device, or a reflection capability of the first communication device;
wherein a power supply signal and/or trigger signal corresponding to the backscatter signal are transmitted by the third communication device.

10. The method according to claim 9, wherein
in a case where supporting of the enhanced backscatter coverage distance capability by the first communication device is determined based on at least the sensitivity of the receiver of the second communication device, the receiver of the second communication device supports an enhanced sensitivity.

11. The method according to claim 10, wherein
the second communication device causes its receiver to support the enhanced sensitivity by reducing a reception bandwidth of the second communication device; and/or,
the second communication device causes its receiver to support the enhanced sensitivity by reducing an insertion loss of a conductive circuit operating on a receive frequency band of the second communication device.

12. The method according to claim 9, wherein
in a case where supporting of the enhanced backscatter coverage distance capability by the first communication device is determined based on at least the receive antenna gain of the second communication device, the second communication device supports an enhanced receive antenna gain.

13. The method according to claim 9, wherein
in a case where supporting of the enhanced backscatter coverage distance capability by the first communication device is determined based on at least the transmit antenna gain of the third communication device, the third communication device supports an enhanced transmit antenna gain;
wherein the transmit antenna gain comprises a diversity gain or a beamforming gain.

14. The method according to claim 9, wherein
in a case where supporting of the enhanced backscatter coverage distance capability by the first communication device is determined based on at least the location information of the third communication device, a distance between the third communication device and the first communication device is less than or equal to a first preset value.

15. The method according to claim 9, wherein
in a case where supporting of the enhanced backscatter coverage distance capability by the first communication device is determined based on at least the frequency shift capability supported by the first communication device, the frequency shift capability supported by the first communication device comprises increasing or decreasing a frequency with a first frequency modulation interval, or the frequency shift capability supported by the first communication device comprises increasing or decreasing a frequency with a plurality of frequency modulation intervals.

16. The method according to claim 15, wherein
the plurality of frequency modulation intervals are defined by a protocol, or the plurality of frequency modulation intervals are configured by a network device.

17. The method according to claim 15, wherein
an operating frequency of the first communication device is modulated from a wireless fidelity (WiFi) signal to a Bluetooth broadcast signal frequency through frequency shift keying modulation (FSK), or the operating frequency of the first communication device is modulated from a cellular network signal to a Bluetooth broadcast signal frequency through FSK.

18. A first communication device, comprising: a transceiver, a processor and a memory; wherein the transceiver is configured to receive and transmit signals, the memory is configured to store a computer program, and the processor is configured to call and run the computer program stored in the memory to cause the communication device to perform:
transmitting a backscatter signal;
wherein the first communication device obtains power through power harvesting for communication, information collection and information processing, and the first communication device supports an enhanced backscatter coverage distance capability.

19. The first communication device according to claim 18, wherein
that the first communication device supports the enhanced backscatter coverage distance capability is determined based on at least one of following:
a sensitivity of a receiver of a second communication device, a receive antenna gain of the second communication device, a transmit power of a carrier signal of a third communication device, a transmit antenna gain of the third communication device, location information of the third communication device, angle information of a scanning antenna of the third communication device, an operating frequency of a carrier signal of the third communication device, an operating frequency of the backscatter signal, a frequency shifting capability supported by the first communication device, or a reflection capability of the first communication device;
wherein a receiving terminal of the backscatter signal is the second communication device, and a power supply signal and/or trigger signal corresponding to the backscatter signal are transmitted by the third communication device.

20. The first communication device according to claim 19, wherein
in a case where supporting of the enhanced backscatter coverage distance capability by the first communication device is determined based on at least the sensitivity of the receiver of the second communication device, the receiver of the second communication device supports an enhanced sensitivity.
